(19) United States
(12) Patent Application Publication
(10) Pub. No.: US 2003/0007559 A1
(43) Pub. Date: Jan. 9, 2003

(54) Apparatus and method for image transmission

(76) Inventors: Arthur Lallet, Gergny (FR); Paola Hobson, Hampshire (GB); Anthony Richard May, Hampshire (GB)

Correspondence Address: Jonathan P Meyer, Motorola Inc, Intellectual Property Section Law Department, 1303 East Algonquin Road, Schaumburg, IL, 60196, US

(21) Appl. No.: 10/070,202

(22) PCT Filed: Jul. 19, 2001
(86) PCT No.: PCT/EP01/08396

(30) Foreign Application Priority Data
Jul. 19, 2000 (GB) 0017660.2

(51) Int. Cl. H04N 7/12

(52) U.S. Cl. 375/240.03; 375/240.12; 375/240.24

(57) ABSTRACT

Apparatus and methods for controlling the amount of data used to transmit still images during the transmission of a video sequence from a first to a second location are disclosed. The apparatus of one embodiment comprises encoding means (105) arrange for intraframe encoding still images for transmission and intraframe encoding part or all of selected video sequence frames, calculating means (106) for determining the data size of intraframe encoded video sequence frames and control means (107) for controlling intraframe encoding of still images for transmission in dependence on the determined intraframe encoded size of a previous video sequence frame. The system can be operated in a way so as to remain H.263 compliant. Other embodiments control the data size by adjusting the quantization used for each Macroblock and by reprocessing each Group of Blocks until a desired data size is reached.

### FIELD OF THE INVENTION

The present invention relates to methods and apparatus for controlling the amount of data used to transmit still images.

### BACKGROUND OF THE INVENTION

Many circumstances exist when it is necessary to transmit video sequences, i.e. moving picture sequences, from one location to another. Various standards exist within which such video transmission is carried out. These standards relate particularly to the compression to which the video signal is subjected prior to transmission.

Examples of video compression standards are ITU (International Telecommunications Union) H.261 and H.263 and MPEG. The H.263 compression standard is currently of particular interest, as it relates to the transmission of video at low bit rates. The H.263 compression standard is thus suitable for use in communication over IP (Internet Protocol) networks and wireless communications networks.

Generally, the H.263 standard is designed for transmission over communication channels which have lower bandwidths than channels typically used for MPEG transmission. However, the H.263 standard is scalable, and can be used to transmit information with a range of communication frequencies. Communication using the H.263 standard may typically be at frequencies in the range of 1-32 kbits/second. In comparison to this, MPEG4 transmits information in a completely different format than H.263. MPEG4 is also scalable to different frequencies, but is designed to transmit at typically 64 kbits/second.

In some circumstances a user may wish to transmit a still image using a system normally used to transmit video sequences. The still image may be, for example, either a freeze frame in a video sequence, or a single frame extracted from a video sequence. Where sending of such still images is carried out in accordance with a still image standard, such as JPEG, there is a need for additional software and hardware at the transmitting and receiving locations.

Further, in any typical transmission system, the amount of bandwidth available and/or the time which the user wishes to commit to the transmission of a still image will be limited. At the same time, the user will require that any transmitted still image has an appropriate quality at the receiving end. The amount of data, or number of bits, used to transmit a still image clearly affects the quality at the receiving end. The number of bits clearly also affects the amount of time required to transmit the image.

Quantisation is a process for quantifying the value of a parameter which may take values within a range. Quantisation can be seen simply as a process of dividing up information into predetermined sub-ranges. Firstly, the whole range of values that a parameter may take is divided up into sub-ranges. Any measured value of the parameter must fall into one of these sub-ranges. For the value that the parameter takes at any particular instant, it is only necessary to decide which one of these sub-ranges the value falls in to. Thus quantistion is analogous to classifying data into ‘bins’.

Once the values of a parameter have been quantised, then a transmitter can transmit to a receiver information about which sub-range the parameter fell into at each point in time. This transmission enables the transmitter to send a reduced quantity of data, compared to what would be required if transmitting each exact value that the parameter took. The transmitter can therefore use a transmission channel of lower bandwidth. The receiver however has a less precise knowledge of the value of the parameter, since the receiver only knows which sub-range the parameter fell into, rather than the exact value which the parameter took.

If the ‘quantisation’ is increased, then the sub-ranges are made larger. This means that the classification of successive values of the parameter is effectively ‘coarser’. As a result, even less data need be transmitted. However, a receiver receives a correspondingly grainier or coarser measurement of the value which the parameter took. So an image with high quantisation will require the transmission of less data than an image of low quantisation, because the data has been compressed more, but the received image will be of lower quality.

It is an object of the invention to provide systems which are suitable for controlling the amount of data used to transmit a still image during the transmission of video sequences, whilst remaining compliant with the transmission standard used when transmitting the video sequence.

Prior art video coding techniques are known from published patent applications EP-A574244 and WO-A-9424823. Other prior art video coding techniques are known from published U.S. Pat. No. 5,978,544 and U.S. Pat. No. 5,692,074.

### SUMMARY OF THE INVENTION

According to one aspect of the present invention, there is provided apparatus for controlling the amount of data used to transmit still images during or after the transmission of a video sequence from a first location to a second location, as claimed in claim 1.

According to a second aspect of the present invention, there is provided a method for controlling the amount of data used to transmit still images during or after the transmission of a video sequence from a first to a second location, as claimed in claim 8.

According to a third aspect of the present invention, there is provided apparatus for controlling the amount of data used to transmit still images, as claimed in claim 15.

According to a fourth aspect of the present invention, there is provided a method for controlling the amount of data used to transmit still images, as claimed in claim 24.

According to a fifth aspect of the present invention, there is provided apparatus for controlling the amount of data used to transmit still images, as claimed in claim 33.

According to a sixth aspect of the present invention, there is provided a method for controlling the amount of data used to transmit still images, as claimed in claim 42.

Each of the above aspects of the invention enables the size of data files used to transmit still images during the transmission of a video sequence to be controlled, with the aim of achieving a desired file size. The above aspects of the invention can be used in such a way as to remain compliant with the standard used for the transmission of the video sequence.

In some embodiments it is also possible to control the size of files used to transmit still images where there has been no preceding video sequence.

Further aspects of the invention are as claimed in the dependant claims. Additional specific advantages are apparent from the following description and figures.

### BRIEF DESCRIPTION OF THE DRAWINGS

FIG. 1 shows the arrangement of Macroblocks and Groups of Blocks in a QCIF picture;

FIG. 2 shows schematically the quantization process used in a typical video compression system;

FIG. 3 shows apparatus for encoding video signals for transmission, and for controlling the size of data files used to transmit still images in accordance with a first embodiment;

FIG. 4 is a flow chart showing the method used for controlling the size of data files used to transmit still images in accordance with the first embodiment;

FIG. 5 shows apparatus for encoding video signals for transmission and for controlling the size of data files used to transmit still images in accordance with a second embodiment;

FIG. 6 is a flow chart showing the method used for controlling the size of data files used to transmit still images in accordance with the second embodiment;

FIG. 7 shows apparatus for encoding video signals for transmission and for controlling the size of data files used to transmit still images in accordance with a third embodiment; and

FIG. 8 is a flow chart showing the method used for controlling the size of data files used to transmit still images in accordance with the third embodiment.

### DESCRIPTION OF EMBODIMENTS OF THE INVENTION

Video compression techniques such as those used within the H.263 and H.261 standards are well known to those skilled in the art, and a detailed description of such techniques is nor necessary in the present application. However, an overview of the process applicable to the H.263 standard is given below to aid in the understanding of the present invention.

In the encoding process, each input video frame is considered to consist of a plurality of blocks, each of which is 16×16 pixels in size and is termed a Macroblock. Each of these Macroblocks is composed of 8×8 pixel blocks which are subjected to a discrete cosine transform (DCT) operation. The resulting coefficients are quantized to reduce the amount of data before it is introduced into the bitstream.

The compression technique works in two ways. First, the DCT and quantization operations aim to isolate the most important data relating to the Macroblock concerned, and to exclude the redundant data. Further compression is obtained because, rather than sending complete details of each frame of the video sequence, a large number of frames are simply represented by data which indicates the changes between the present frame and the previous frame. Frames that are processed without reference to any earlier frame are said to be intraframe encoded frames. However, frames that are processed and transmitted by way of indicating the changes between that frame and a previous frame are said to be interframe encoded. When an interframe encoded frame is received at a receiver, then the image to be displayed is regenerated by the receiver using the information concerning the changes in the image, to appropriately modify the previously decoded frame.

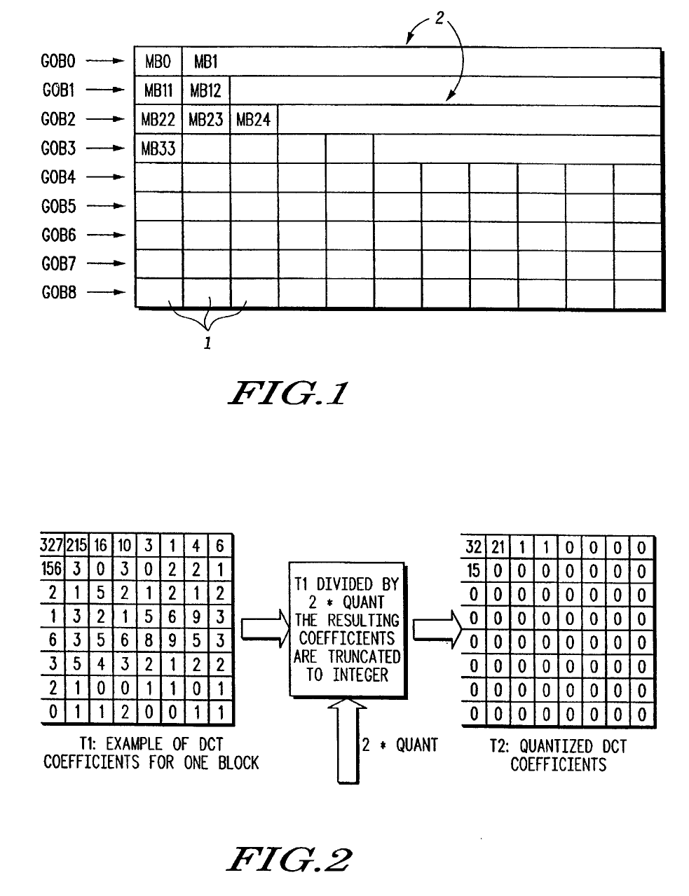

FIG. 1 shows the arrangement of Macroblocks (MBs) 1 in a QCIF (Quarter Common Intermediate Format—176 pixels×144 lines) picture. A QCIF picture is divided into nine Groups of Blocks (GOBs) 2, each of which comprises eleven Macroblocks 1 arranged horizontally across the picture. Note that in FIG. 1 some of the Macroblocks are not shown, to simplify the figures and thereby ease understanding. In the bitstream, headers are provided for each Macroblock 1, each Group of Blocks 2 and each frame as a whole.

In the embodiments of the invention, as described in more detail below, controlling of a quantization factor used in quantization of the DCT coefficients for each Macroblock is used to control the overall data size of encoded still images.

FIG. 2 shows schematically the quantization process carried out on the DCT coefficients calculated for a single block within a Macroblock 1. Matrix T1 shows an exemplary set of DCT coefficients for a single block. The level of quantization carried out on each Macroblock can be adjusted by means of a quantization parameter “QUANT”. The quantisation parameter can be associated with a single Macroblock, the whole image or any sub-combination of Macroblocks. Matrix T2 shows the quantized DCT coefficients which are calculated by dividing the DCT coefficients for the block T1 by the calculated quantization value, 2*QUANT, and truncating the results to integer. In this example, QUANT=5.

This process of quantization typically leads to a large number of zero entries in the quantized DCT coefficient table T2, because all results of dividing T1 by 2*QUANT which are below 1 are set to zero.

When the quantized DCT coefficients in T2 are encoded for transmission, the coefficients are ordered in the bitstream in a preselected order and the bitstream for that particular block is truncated after the last non-zero quantized coefficient. In order that the signal can be dequantized at the receiving end, the quantization parameter QUANT used for each Macroblock is also transmitted in the bitstream. In H.263, there are three ways in which the quantization parameter QUANT can be communicated to the receiving end. First of all, in the header for the whole frame, a quantization parameter PQUANT is included. PQUANT is used for all of the Macroblocks in that frame unless other instructions are issued. Secondly, a quantization parameter GQUANT is included in the header for each Group of Blocks. The value of GQUANT will be used for quantization of each of the Macroblocks in the respective Group of Blocks in preference to PQUANT unless other instructions are received. A third level of flexibility is provided by a quantization parameter DQUANT. DQUANT is included in the header for each Macroblock, and serves to determine the quantization to be used for that specific Macroblock.

In practice, the values of PQUANT and GQUANT are absolute values, whereas DQUANT is used to increment or decrement the current value of PQUANT or GQUANT as appropriate.

As is well known to those in the art, and can be seen from FIG. 2 and the above description, changing the value of the quantization factor Q by altering the quantization parameters PQUANT, GQUANT and DQUANT can significantly change the size of data file used to transmit images. This change in size will significantly affect the quality of a transmitted still image, and the time required to transmit the still image.

In each of the embodiments described below, the apparatus is suitable for transmitting a video sequence in accordance with the H.263 standard. This is carried out in a standard way and no detailed consideration of that process is given below.

In operation of the present embodiments, a video sequence encoded in accordance with H.263 may be being sent from a camera to a remote display. At some point during the video transmission, a user will indicate to the system that a high quality still image is required. The user may be at either the camera or the display end. This indication may be made by pressing an appropriate button or any other suitable means. Once such an indication has been made, the encoder at the transmission end will modify its operation and generate an encoded still image to be inserted into the bitstream for transmission.

It is this modified operation, and in particular the control of the size of data file used to transmit the still image, which is of particular importance in the present invention. This modified operation is described separately below in respect of three embodiments.

First Embodiment of the Invention

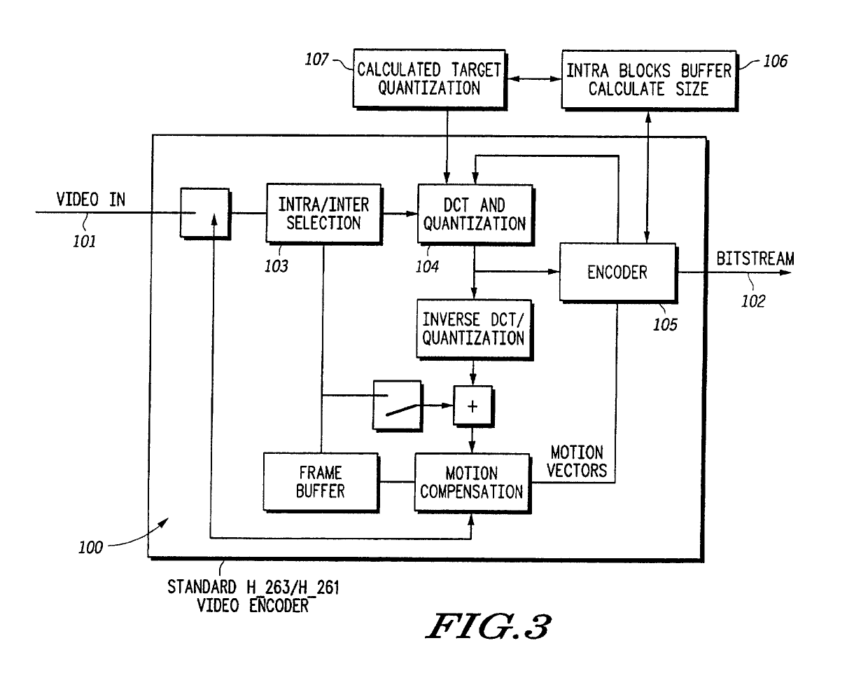

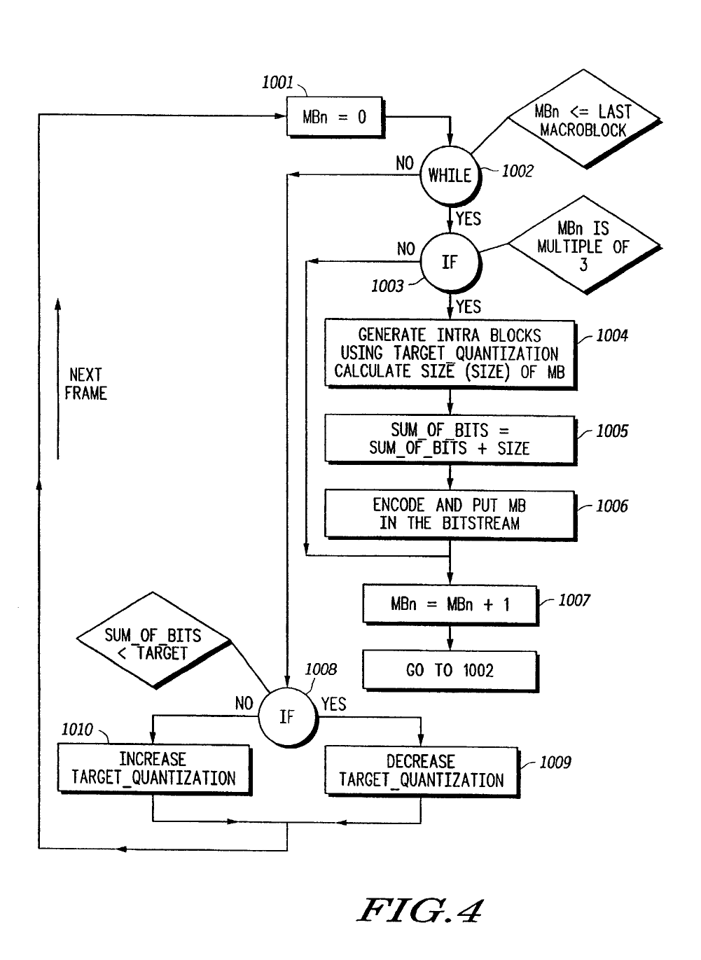

FIG. 3 shows apparatus for encoding video signals for transmission and for controlling the size of data files used to transmit still images in accordance with a first embodiment of the present invention. In this embodiment it is assumed that video sequences are to be transmitted within the H.263 standard. The apparatus comprises a standard H.263/H.261 video encoder 100, which is arranged to receive a video signal at an input 101 and output an encoded bitstream at an output 102.

Since the structure and operation of a standard H.263/H.261 video encoder 100 are well known to those skilled in the art, no detailed description is given in this application. However, to aid in understanding of the present invention, it is noted that the standard video encoder 100 includes means for selecting between intraframe and interframe encoding 103, means for performing a DCT and quantization operations 104, and an encoder 105 for encoding the resulting coefficients of the DCT and quantization operations into a suitable form to be output into the bitstream.

In normal operation, the standard video encoder 100 receives video signals at the input 101, performs operations to determine whether each frame should be intraframe or interframe encoded, performs the necessary DCT and quantization operations on each of the Macroblocks in the image and then encodes these for output into the bitstream. In normal operation, some frames of a video sequence will be interframe encoded and other frames will be intraframe encoded.

In the present embodiment, in addition to the standard video encoder 100, an encoder control unit 106 and a quantization calculation and control unit 107 are provided. The encoder control unit 106 is connected to the encoder 105 of the standard video encoder 100 and to the quantization calculation and control unit 107. The quantization calculation and control unit 107 is also connected to the DCT and quantization means 104 of the standard video encoder 100.

In the present embodiment, the video encoder 100 performs its normal operation in respect of each video sequence frame, generating mainly interframe Macroblocks for introduction into the bitstream. However, the encoder control unit 106 also causes video encoder 100 to intraframe encode selected Macroblocks in each frame, using a preselected PQUANT value.

These intraframe coded Macroblocks are not put into the bitstream, but rather are fed to the encoder control unit 106. Here they are used to calculate the size of data file which would have to be sent if the current video sequence frame were to be sent as an intraframe encoded still image. This calculated size is output from the encoder control unit 106 to the quantization control and calculation unit 107. At the same time, the intraframe encoded blocks supplied to the encoder controller unit 106 are stored in a buffer for possible later use if, for example, they are requested by a receiving unit which has lost synchronisation.

On the basis of the calculated size of the hypothetical still image frame, the quantization calculation and control unit 107 selects a value for PQUANT which should be used if a still frame is requested by a user following that video sequence frame. This process is repeated for each video sequence frame so that the quantization calculation and control unit 107 always retains a value for PQUANT which has been selected on the basis of the last video sequence frame to be sent.

If and when a still frame is requested by a user, the quantization calculation and control unit 107 supplies the calculated value for PQUANT to the DCT and quantization means 104 of the video encoder 100. The encoder controller unit 106 sends an instruction to the encoder 105 that the next frame is to be sent as an intraframe encoded still image.

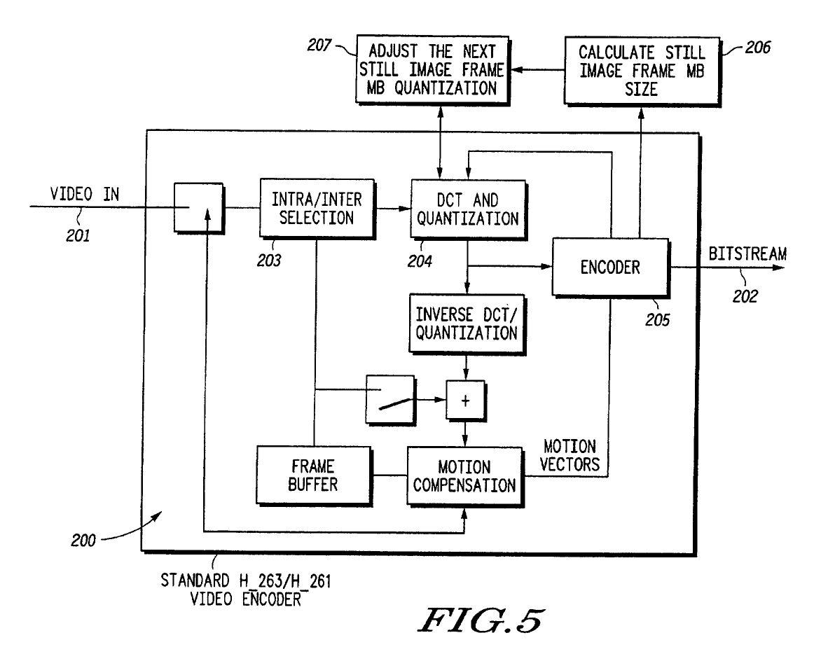

The process followed in order to determine the value of PQUANT to be used for a requested still image is described in greater detail below with reference to the flow chart shown in FIG. 4.

The process illustrated in FIG. 4 is carried out in respect of each video sequence frame. A variable “target_quantization” is a variable parameter which will be used for PQUANT in encoding any subsequent frame. Thus the process in FIG. 4 is aimed at finding the correct value for target_quantization. When processing the first frame, target quantization is set to a default value. In subsequent frames, the previous value of target_quantization is used as a starting point.

In step 1001, at the start of the processing of each frame, a Macroblock counter (MBn) is set to zero.

At step 1002 it is determined whether all of the Macroblocks in the frame have been processed, by determining whether the value in the Macroblock counter is smaller than the value of the final Macroblock. Whilst the value of the Macroblock counter remains smaller than the value for the last Macroblock, the process continues.

At step 1003, it is determined whether the Macroblock counter shows a value which is a multiple of 3. If it is determined that the Macroblock counter has a value which is a multiple of 3, then the corresponding Macroblock is processed to generate an intraframe encoded block, using the current target_quantization, and the data size (size) of the encoded Macroblock is calculated at step 1004. At step 1005, the total number of bits (sum_of_bits) used for the Macroblocks encoded so far is calculated.

On the other hand, when at step 1003 it is determined that the Macroblock counter is not a multiple of 3, then steps 1004 and 1005 are skipped. This has the effect that in each frame, only every third Macroblock is encoded in the process for determining the size of the respective hypothetical still image.

At step 1006, following step 1005 or 1003 as appropriate, each Macroblock is encoded as part of the video sequence and put into the bitstream. This encoding is quite separate from the intraframe encoding carried out in step 1004 and is rather the encoding which would take place if the standard video encoder 100 were operating in its usual fashion. Therefore the encoding process at step 1006 will normally consist of interframe encoding.

At step 1007, the Macroblock counter is incremented by one so that steps 1002 to 1006 are repeated for the next Macroblock. Once the final Macroblock in the frame has been subjected to steps 1003 to 1006, the inequality tested at step 1002 will no longer be true and the process passes to step 1008.

At step 1008 it is determined whether sum_of_bits, as calculated in step 1005, is smaller than a target value. If it is determined, at step 1008, that sum_of_bits is smaller than the target value, this indicates that the target_quantization value used would be expected to generate a still image which would have a too small data size. Such a still image would not provide the maximum quality allowed by the data size/transmission time available for sending a still image. Therefore at step 1009 target_quantization is decreased in such a case.

However, if it is determined at step 1008 that sum_of_bits is not smaller than the target, then this indicates that target_quantization as presently set would generate a data file which is too large. Correspondingly, at step 1010, target_quantization is increased.

If sum_of_bits is equal to the target value, then target_quantization is left unchanged. This decision step has been omitted from FIG. 4 for clarity of illustration.

The modified target_quantization as determined in step 1009 or 1010 becomes the value of PQUANT which is stored in the quantization calculation and control unit 107. This is the value of PQUANT which will be used in encoding a still frame, should a request for such a still frame be made.

Whilst only every third Macroblock is encoded in step 1004 in the above embodiment, this is merely exemplary. A different number of Macroblocks may be encoded per image. For example, it is possible to encode every Macroblock in each image or only every fourth or fifth Macroblock. There is a trade off between processor usage and the accuracy of the determined encoded picture size which must be considered when choosing how frequently to encode Macroblocks. The more Macroblocks are encoded per image, the greater the accuracy of the determined encoded picture size, but the greater the processor usage.

The above embodiment has advantages since it allows the real time transmission of still images, it is relatively straightforward to generate intraframe coded Macroblocks for each frame, and the calculations required are simple. Further, the additionally generated intraframe Macroblocks can be stored and may be useful for other purposes, for example they may be provided to late joiners to a group video call.

In the above embodiment, an attempt is made to determine the encoded size of a requested still image by relying on calculations made in respect of the previous video sequence frame. Therefore the method will not work if there is no preceding image frame and the effectiveness of the method is governed by how much the images change from one frame to the next. If the frame rate is low and the scene is moving, or scene cuts occur, then the encoded size of a still image may be significantly greater or much smaller than expected from this predictive technique.

Although in the first embodiment a calculation is made of the size of a hypothetical still image in respect of each video sequence frame, it is possible to perform this calculating function less often. As an example, the size of a hypothetical still frame may be calculated for only every other video sequence frame.

Second Embodiment of the Invention

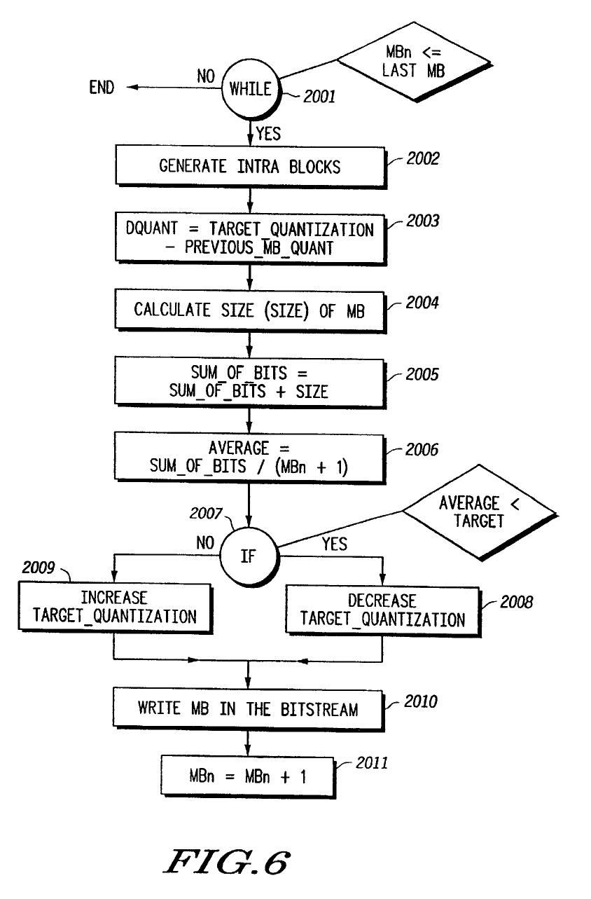

FIG. 5 shows apparatus for encoding video signals for transmission and for controlling the size of data files used to transmit still images, in accordance with a second embodiment of the invention.

The apparatus shown in FIG. 5 is similar to that used in the first embodiment shown in FIG. 3. The apparatus of FIG. 5 comprises a standard H.263/H.261 video encoder 200, a video signal input 201, an output 202, an intraframe encoding and interframe encoding selection means 203, a DCT and quantization processing means 204 and an encoder 205. The above mentioned components correspond to those in the first embodiment having the same reference numerals, except being preceded by a 1 rather than a 2. The standard video encoder 200 operates in substantially the same way as the standard video encoder 100.

In the second embodiment however, the apparatus and method used for controlling the data size of intraframe encoded still images are different from those in the first embodiment. In the second embodiment, rather than the same quantization factor being used for the whole of each frame, the quantization factor for each Macroblock may be different. This is achieved by making use of the quantization parameter DQUANT which is defined within the H.263 standard, rather than relying on the PQUANT parameter used in the first embodiment.

Further, in the second embodiment, rather than continually carrying out processing of the video data to calculate an appropriate quantization for a large number of hypothetical still images, calculations are only made when a still image is actually to be sent. In many cases a still image will only be requested rarely, so this difference can reduce significantly the number of calculations which need to be carried out.

The apparatus of the second embodiment comprises a Macroblock size calculation unit 206 and a quantization calculation and control unit 207. The Macroblock size calculation unit 206 is connected to the encoder 205 of the standard video encoder 200 and to the quantization calculation and control unit 207. In turn, the quantization calculation and control unit 207 is, connected to the DCT and quantization processing means 204 of the standard video encoder 200.

In the second embodiment, when a user makes a request to initiate the transmission of a still image, the quantization calculation and control means 207 causes the DCT and quantization processing means 204 and encoder 205 to begin generation of an intraframe encoded frame. The value of PQUANT used in the last video sequence frame to be encoded is used for quantization of the first Macroblock in the still frame. Thereafter, the quantization factor used for each Macroblock is adjusted as required by the quantization calculation and control unit 207. Details of the quantization used for each Macroblock are put into the bitstream by making use of the quantization parameter DQUANT.

The process for controlling the size of an encoded still image is explained in more detail below, with particular reference to the flow chart shown in FIG. 6.

The process shown in the flow chart of FIG. 6 is carried out in respect of each still image which is requested. A Macroblock counter (MBn) is first set to zero, and in step 2001 it is determined whether the Macroblock to be processed is the final one in the frame. Until the final Macroblock is reached the following steps are executed.

At step 2002, the Macroblock is operated on to generate the intraframe encoded Macroblock, a current value of target_quantization being used in the quantization process. For the first Macroblock in each still image this target_quantization equates to PQUANT from the previous video sequence frame. For all subsequent Macroblocks, the target_quantization equates to a newly calculated value of target quantization determined in the way described below.

At step 2003, the value of DQUANT to be included in the Macroblock header is calculated, based on a subtraction of the target_quantization used for the previous Macroblock from the current target quantization.

At step 2004 the data size (size) of the encoded Macroblock is calculated. At step 2005, the size of the current Macroblock is added to a sum of all the previously encoded Macroblocks within that frame (sum_of_bits).

At step 2006 the average size of all of the Macroblocks so far encoded in the still frame is calculated. In the calculation of this average it is noted that the value of MBn+1 is used since the value of MBn for the first Macroblock is zero.

At step 2007 the average calculated in step 2006 is compared with a target value which corresponds to the desired size of the still image. If the average is smaller than the target value, then target_quantization is decreased at step 2008. If the average is greater than the target then, at step 2009 target_quantization is increased.

If the average is equal to the target value then target_quantization is unchanged. This step is not shown in FIG. 6 for simplicity of illustration.

At step 2010 the current Macroblock is put into the bitstream and at step 2011 the Macroblock counter is increased by one so that the process is repeated for the next Macroblock in the frame.

The method of FIG. 6 involves calculating the average number of bits per macroblock, after encoding each macroblock, and comparing this average with the target size of data for transmission. The result of this comparison indicates whether the quantisation needs to be increased or decreased, and the quantisation is adjusted by setting DQUANT.

In the second embodiment of the invention, undesirable visual affects can occur if the quantization between adjacent Macroblocks is changed too abruptly. Therefore, it has been found preferable to set a maximum allowed change in target_quantization, in steps 2008 and 2009, at two per Macroblock. The value of any such limit may be chosen empirically, so as to reduce the undesirable effects on the image to an acceptable level.

In an alternative, rather than allowing a change in target_quantization for each Macroblock, the quantization calculation and control means 207 may be arranged to keep the quantization constant for a preselected number of consecutive Macroblocks between each change.

The second embodiment has advantages because it is simple to implement, and because the number of calculations is limited, since these are only performed during the encoding of a still image. However, there is a limit to the efficiency of the system, because large numbers of bits may be assigned to plain areas of the image, leaving few for detailed areas

Third Embodiment of the Invention

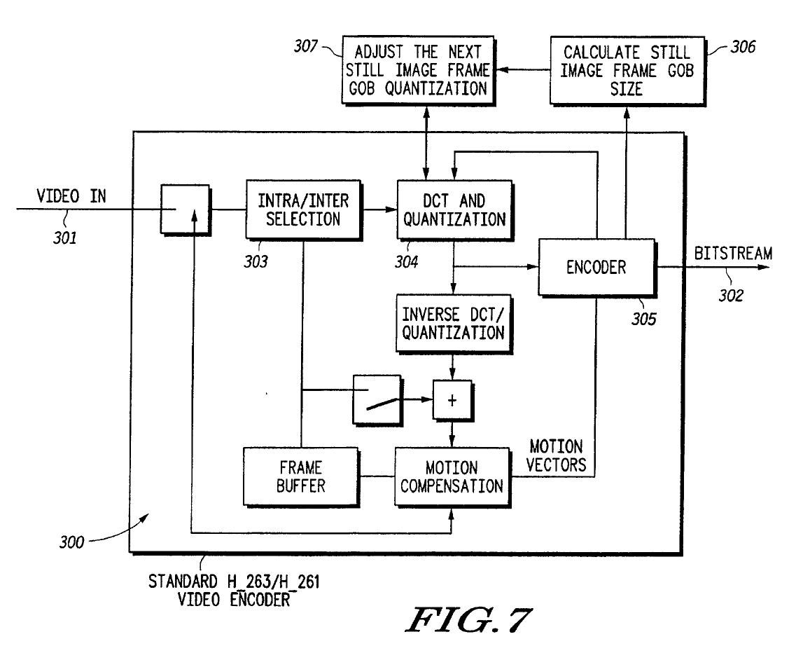

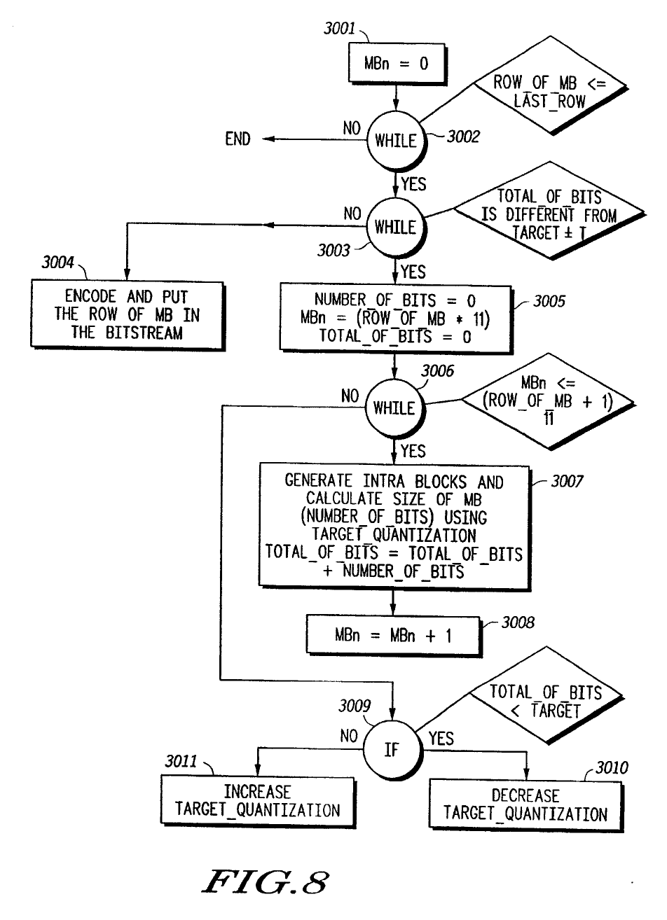

FIG. 7 shows an apparatus for encoding video signals for transmission and for controlling the size of data files used to transmit still images in accordance with a third embodiment of the present invention.

The apparatus of the third embodiment is similar to that of the first and second embodiments. The apparatus of the third embodiment comprises a standard H.263/H.261 video encoder 300 having a video input 301, an output 302, intraframe and interframe selection means 303, DCT and quantization processing means 304, and an encoder 305. The above mentioned components and their operation correspond to those in the first and second embodiments having the same reference numerals except being preceded by 3 rather than 1 or 2.

Similarly to the second embodiment, in the third embodiment, the processing used to control the size of intraframe encoded still image frames is only carried out when actually encoding such still images. In the third embodiment, rather than using the same quantization for the whole of the still image as in the first embodiment, or allowing the quantization used for each Macroblock to change as in the second embodiment, a quantization factor is assigned to each Group of Blocks. This quantization factor is used for all Macroblocks within that GOB, by making use of the quantization parameter GQUANT included in the Group of Blocks header.

The apparatus of the third embodiment comprises a Group of Blocks size calculation unit 306 and a quantization calculation and control unit 307. The Group of Blocks size calculation unit 306 is connected to an output of the encoder 305 of the standard video encoder 300, and is connected to the quantization calculation and control unit 307. In turn the quantization calculation and control unit 307 is connected to the DCT and quantization processing means 304 of the standard video encoder 300.

In the third embodiment, a proportion of the desired data size for the whole image is apportioned to each Group of Blocks in proportion with its physical size. Thus in the case of a QCIF picture of the type shown in FIG. 2, a ninth of the total desired data size is assigned to each of the Group of Blocks. Each Group of Blocks is then encoded using an initial trial quantization and it is determined whether the total number of bits used to encode this Group of Blocks falls within a target range.

If the number of bits, i.e. the data size of that Group of Blocks, falls within the desired target range then the Group of Blocks is encoded and put into the bitstream. On the other hand, if the data size falls outside the target range, then that Group of Blocks is re-encoded using a different quantization, and its size is again tested. This process is repeated until the size for the Group of Blocks falls within the desired range or until some time period expires, the time period being selected to be consistent with the user's preference for image communication delay. Once the correct quantization for a Group of Blocks has been determined, this is included in the bitstream. The quantization is included in the bitstream by using PQUANT for the first Group of Blocks, and by using GQUANT for the remaining Groups of Blocks in the still image. PQUANT is used for the first Group of Blocks because, as defined in the H.263 standard, the first Group of Blocks header in each frame cannot be transmitted.

The process used to control the data size of each Group of Blocks, and hence the whole encoded frame, is described in more detail below with reference to FIG. 8.

In step 3001 a Macroblock counter (MBn) is set to zero at the start of processing a still frame to be transmitted. At step 3002 it is determined whether the row number of the Macroblock (row_of_MB) to be processed is smaller or equal to the final row. If this is not the case, then processing of the still image is complete, and the process stops. If the row number of the Macroblock is smaller or equal to the final row, then the following steps are executed.

At step 3003 it is determined whether the total number of bits for the Group of Blocks (Total_of_bits) falls outside the target range (target+/−T). In this expression, T is a preselected tolerance, a suitable value for which can be determined by carrying out experiments. A typical tolerance is +/−5% of the target size. When the total number of bits falls within the target range then processing of that Group of Blocks is complete and the Group of Blocks is encoded and put into the bitstream in step 3004. If, on the other hand, at step 3003 it is determined that Total_of_bits falls outside the target range then the following steps are executed.

At step 3005 a ‘number_of_bits’ variable is set to zero, ‘Total_of bits’ is set to zero and the Macroblock counter is set to (row_of_MB*11).

At step 3006, it is determined whether the Macroblock counter is smaller than or equal to (row_of_MB+1)*11. This inequality is true for each Macroblock in a respective Group of Blocks and step 3006 therefore ensures that the following steps are carried out in respect of each Macroblock of the respective Group of Macroblocks before the inequality fails to hold.

In step 3007 an intraframe encoded Macroblock is generated for the present Macroblock using the current target_quantization and the data size (number_of_bits) of the encoded Macroblock calculated. Further, the data size of this Macroblock is added to a total size (Total_of_bits) of all the Macroblocks in that Group of Blocks which had already been encoded. At step 3008 the Macroblock counter is incremented by one so that the above processes are repeated for the next Macroblock.

When at step 3006 it is determined that the last Macroblock in a respective Group of Blocks has been processed, Total_of_bits as calculated at step 3007 is compared with a target at step 3009. If at step 3009 it is determined that Total_of_bits is smaller than the target, then at step 3010 target_quantization is decreased, whereas if it is determined that Total_of_bits is not smaller than the target, then target_quantization is increased at 3011. If Total_of_bits is equal to the target, then target_quantization is unchanged. This latter condition is not shown in FIG. 8, for simplicity of illustration.

The procedure then runs through steps 3005 to 3011 as appropriate until it is determined, at step 3003, that Total_of_bits falls within the target range (target +/−T) or some time period expires according to the user's preference for image communication delay.

Once the correct quantization has been found for that Group of Blocks, the Macroblocks are encoded and introduced into the bitstream together with the appropriate value of GQUANT, at step 3004 as mentioned above. The process then repeats steps 3003 to 3011 for the next Group of Blocks until the whole frame has been encoded.

It has been found that the use of the third embodiment gives rise to good image quality. Furthermore, the data size for the whole image, and hence the desired transmission time, can be accurately targeted, because each Group of Blocks may be re-encoded until it falls within a target range. However, there is a trade off with this method since its implementation is complex and there are significant demands placed on processing power.

It will be clear from the above description that the standard video encoder 300 must allow Macroblocks to be encoded row by row, i.e. Group of Macroblocks by Group of Macroblocks.

Each of the above embodiments gives advantages because they allow still images to be sent, whilst remaining compliant with a video compression standard. This means that the existing hardware/software of the video sequence encoder can be used. Thus there are significant advantages over systems which use a different standard for the transmission of still images, such as JPEG, because in such a case there would be a requirement for additional hardware and/or software.

Each of the above embodiments may be improved with regard to the allocation of bits to areas of the image which are more important. That is to say, the embodiments may be modified so that an area in each image can be designated as a “region of interest”, in which a lower quantization factor is used to retain more image information. Whilst it is possible to use regions of interest with each of the embodiments, it is significantly more straightforward to implement this with the second and third embodiments.

The order in which Macroblocks are encoded can be modified and this can assist where regions of interest have been designated.

In a modified form of the second embodiment, Macroblocks in a region of interest may first be encoded using quantization factors chosen to give a high quality image. This may use a large amount of the available data size for the complete still image. The remainder of the image may then be encoded using quantization factors for each Macroblock that are chosen to ensure that the overall data size of the encoded image approaches the desired target.

In a modified form of the third embodiment it would be a simple matter to assign a larger proportion of the available data size to one or more of the Groups of Macroblocks. On the other hand, assigning more of the available data size to individual Macroblocks within a Group of Blocks might be more difficult, but it is also possible. Again, in such a case it would be possible to first encode Macroblocks in each Group of Blocks which were within the region of interest, to give the desired quality, and then encode the remainder of the Macroblocks in each Group of Macroblocks. The remainder of the Macroblocks in each Group of Macroblocks would be encoded with a quantization chosen such that the overall data size of the respective Group of Blocks fell within the desired target range.

1. Apparatus for controlling the amount of data used to transmit still images during or after the transmission of a video sequence from a first to a second location, the apparatus comprising:
encoding means arranged for intraframe encoding still images for transmission and intraframe encoding part or all of selected video sequence frames;
calculating means for determining the data size of intraframe encoded video sequence frames; and
control means for controlling intraframe encoding of still images for transmission in dependence on the determined intraframe encoded size of a previous video sequence frame.

2. Apparatus according to claim 1, in which the encoding means is arranged to intraframe encode part or all of each video sequence frame and the control means is arranged to control intraframe encoding of a still image in dependence on the determined size of the most recently intraframe encoded video sequence frame.

3. Apparatus according to claim 1 or claim 2 in which the control means is arranged to select a quantization factor for use in encoding of a still image in dependence on the determined intraframe encoded size of a previous video sequence frame.

4. Apparatus according to claim 1 or claim 2 in which the control means is arranged to select, in dependence on the determined intraframe encoded size of a previous video sequence frame, a first quantization factor for use in encoding a first part of a still image and a second quantization factor for use in encoding a second part of a still image.

5. Apparatus according to any preceding claim in which the encoding means is arranged to carry out an encoding process in which an image is considered to comprise a plurality of blocks, each of which is intraframe encoded.

6. Apparatus according to any preceding claim in which the control means is arranged to control intraframe encoding of still images with the aim of keeping the data size of the encoded image within predetermined limits.

7. Apparatus according to any preceding claim in which the encoding and transmission of the still images is compatible with the scheme used for encoding and transmitting of the video sequence.

8. A method for controlling the amount of data used to transmit still images during or after the transmission of a video sequence from a first to a second location, the method comprising the steps of:
intraframe encoding part or all of selected video sequence frames;
determining the data size of intraframe encoded video sequence frames; and
when sending a still image, controlling intraframe encoding of said image in dependence on the determined intraframe encoded size of a previous video sequence frame.

9. A method according to claim 8, comprising the steps of intraframe encoding part or all of each video sequence frame and controlling intraframe encoding of a still image in dependence on the determined size of the most recently intraframe encoded video sequence frame.

10. A method according to claim 8 or claim 9, comprising the step of selecting a quantization factor for use in encoding a still image in dependence on the determined intraframe encoded size of a previous video sequence frame.

11. A method according to claim 8 or claim 9 comprising the step of selecting, in dependence on the determined intraframe encoded size of a previous video sequence frame, a first quantization factor for use in encoding a first part of a still image and a second quantization factor for use in encoding a second part of a still image.

12. A method according to any one of claims 8 to 11 in which the encoding process is one in which an image is considered to comprise a plurality of blocks each of which is intraframe encoded.

13. A method according to any one of claims 8 to 12 in which the intraframe encoding of still images is conducted with the aim of keeping the data size of the encoded image within predetermined limits.

14. A method according to any one of claims 8 to 13 in which the encoding and transmission of the still images is compatible with the scheme used for encoding and transmitting of the video sequence.

15. Apparatus for controlling the amount of data used to transmit still images, the apparatus being suitable for use during the transmission of a video sequence from a first to a second location and comprising:
encoding means arranged for intraframe encoding still images for transmission, the encoding process being one in which a still image is considered to comprise a plurality of blocks each of which is intraframe encoded;
calculating means for determining the data size of intraframe encoded blocks; and
control means for controlling encoding of selected blocks in dependence on the determined data size of one or more previously encoded block.

16. Apparatus according to claim 15 in which the control means is arranged to select a quantization factor for use in encoding of a selected block in dependence on the determined size of one or more previously encoded block.

17. Apparatus according to claim 15 or claim 16 in which the control means is arranged to select a quantization factor for use in encoding of a selected block by incrementing or decrementing a quantization factor used for a previously encoded block.

18. Apparatus according to claim 17 in which the control means comprises means for calculating the average data size of previously encoded blocks within the respective image, the control means being arranged to select the quantization factor for use in encoding of a selected block by incrementing a quantization factor used for a previously encoded block where the average data size falls on one side of a target range or value and by decrementing a quantization factor used for a previously encoded block where the average data size falls on an opposite side of the target range or value.

19. Apparatus according to claim 17 or claim 18 in which a maximum limit to the change in quantization factor caused by each incrementation or decrementation is chosen to limit undesirable visual effects in decoded images.

20. Apparatus according to any one of claims 17, 18 and 19 in which the quantization factor is kept constant for a selected number of consecutive blocks, the selected number being chosen to limit undesirable visual effects in decoded images.

21. Apparatus according to any one of claims 15 to 20 in which the control means is arranged to control intraframe encoding of still images with the aim of keeping the data size of the encoded image within predetermined limits.

22. Apparatus according to any one of claims 15 to 21 in which the control means is arranged to select the quantization factors for blocks in a selected part of a still image to give a desired image quality and to select the quantization factors for the remainder of the still image on the basis of a desired data size for the complete encoded image.

23. Apparatus according to any one of claims 15 to 22 in which the encoding and transmission of the still images is compatible with the scheme used for encoding and transmitting of the video sequence.

24. A method for controlling the amount of data used to transmit still images, the method being suitable for use during the transmission of a video sequence from a first to a second location and comprising the steps of:
intraframe encoding still images for transmission, the encoding process being one in which a still image is considered to comprise a plurality of blocks each of which is intraframe encoded;
determining the data size of intraframe encoded blocks; and
controlling encoding of selected blocks in dependence on the determined data size of one or more previously encoded block.

25. A method according to claim 24 comprising the step of selecting a quantization factor for use in encoding of a selected block in dependence on the determined size of one or more previously encoded block.

26. A method according to claim 24 or claim 25 comprising the step of selecting a quantization factor for use in encoding of a selected block by incrementing or decrementing a quantization factor used for a previously encoded block.

27. A method according to claim 26 comprising the steps of:
calculating the average data size of previously encoded blocks within the respective image; and
selecting the quantization factor for use in encoding a selected block by incrementing a quantization factor used for a previously encoded block where the average data size falls on one side of a target range or value and by decrementing a quantization factor used for a previously encoded block where the average data size falls on an opposite side of the target range or value.

28. A method according to claim 26 or claim 27 in which a maximum limit to the change in quantization factor caused by each incrementation or decrementation is chosen to limit undesirable visual effects in decoded images.

29. A method according to any one of claims 26 27 and 28 in which the quantization factor is kept constant for a selected number of consecutive blocks, the selected number being chosen to limit undesirable visual effects in decoded images.

30. A method according to any one of claims 24 to 29 in which the intraframe encoding of still images is conducted with the aim of keeping the data size of the encoded image within predetermined limits.

31. A method according to any one of claims 24 to 30 comprising the steps of first selecting the quantization factors for blocks in a selected part of a still image to give a desired image quality and subsequently selecting the quantization factors for the remainder of the still image on the basis of a desired data size for the complete encoded image.

32. A method according to any one of claims 24 to 31 in which the encoding and transmission of the still images is compatible with the scheme used for encoding and transmitting of the video sequence.

33. Apparatus for controlling the amount of data used to transmit still images, the apparatus being suitable for use during the transmission of a video sequence from a first to a second location and comprising:
encoding means arranged for intraframe encoding still images for transmission, the encoding process being one in which a still image is considered to comprise a plurality of blocks each of which is intraframe encoded;
calculating means for determining the data size of part of an intraframe encoded image comprising at least one intraframe encoded block;
judging means for determining whether the determined data size of said part of an intraframe encoded image falls within a preselected range; and
control means for causing re-encoding of said part of an intraframe coded frame, prior to transmission, in such a way as to change the data size of said part of an intraframe coded image when the determined data size falls outside the preselected range.

34. Apparatus according to claim 33 in which the control means is arranged to select quantization factors for use in encoding and re-encoding still images.

35. Apparatus according to claim 34 in which the control means is arranged to change the data size of said part of an intraframe coded image, when re-encoding said part, by selecting a quantization factor different from that used in the previous encoding of said part.

36. Apparatus according to any one of claims 33 to 35 in which the control means is arranged to cause repetition of the re-encoding process until the determined data size falls within the preselected range.

37. Apparatus according to any one of claims 33 to 36 in which a desired data size for the whole of an encoded image is chosen and the preselected range for parts of the image are determined by assigning desired data sizes to parts in accordance with the relative physical size of each part of the image.

38. Apparatus according to any one of claims 33 to 37 in which a desired data size for the whole of an encoded image is chosen and the preselected range for parts of the image are determined by assigning desired data sizes to parts in accordance with the relative importance of each part of the image.

39. Apparatus according to any one of claims 33 to 38 in which said part of an intraframe coded image comprises a Group of Blocks.

40. Apparatus according to any one of claims 33 to 39 in which the control means is arranged to control intraframe encoding of still images with the aim of keeping the data size of the encoded image within predetermined limits.

41. Apparatus according to any one of claims 33 to 40 in which the encoding and transmission of the still images is compatible with the scheme used for encoding and transmitting of the video sequence.

42. A method for controlling the amount of data used to transmit still images, the method being suitable for use during the transmission of a video sequence from a first to a second location and comprising the steps of:
intraframe encoding still images for transmission, the encoding process being one in which a still image is considered to comprise a plurality of blocks each of which is intraframe encoded;
determining the data size of part of an intraframe encoded frame comprising at least one intraframe encoded block;
determining whether the determined data size of said part of an intraframe coded frame falls within a preselected range; and
when the determined data size falls outside the preselected range, re-encoding said part of an intraframe coded frame, prior to transmission, in such a way as to change the data size.

43. A method according to claim 42. comprising the step of selecting quantization factors for use in encoding and re-encoding still images.

44. A method according to claim 43 comprising the step of, when re-encoding said part of an intraframe coded image, selecting a quantization factor which is different from that used in the previous encoding of said part.

45. A method according to any one of claims 42 to 44 comprising the step of repeating the re-encoding process until the determined data size falls within the preselected range.

46. A method according to any one of claims 42 to 45 comprising the steps of choosing a desired data size for the whole of an encoded image and determining the preselected range for parts of the image by assigning desired data sizes to parts in accordance with the relative physical size of each part of the image.

47. A method according to any one of claims 42 to 46 comprising the steps of choosing a desired data size for the whole of an encoded image and determining the preselected range for parts of the image by assigning desired data sizes to parts in accordance with the relative importance of each part of the image.

48. A method according to any one of claims 42 to 47 in which said part of an intraframe coded image comprises a Group of Blocks.

49. A method according to any one of claims 42 to 48 in which the control means is arranged to control intraframe encoding of still images with the aim of keeping the data size of the encoded image within predetermined limits.

50. A method according to any one of claims 42 to 49 in which the encoding and transmission of the still images is compatible with the scheme used for encoding and transmitting of the video sequence.
